(19) United States
(12) Patent Application Publication
(10) Pub. No.: US 2010/0013935 A1
(43) Pub. Date: Jan. 21, 2010

(54) MULTIPLE TARGET TRACKING SYSTEM INCORPORATING MERGE, SPLIT AND REACQUISITION HYPOTHESES

(75) Inventors: Yunqian Ma, Roseville, MN (US); Qian Yu, Los Angeles, CA (US); Isaac Cohen, Minnetonka, MN (US)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: HONEYWELL INTERNATIONAL INC., Morristown, NJ (US)

(21) Appl. No.: 11/761,171

(22) Filed: Jun. 11, 2007

Related U.S. Application Data
(63) Continuation-in-part of application No. 11/548,185, filed on Oct. 10, 2006.
Application No. 11/548,185 is a continuation-in-part of application No. 11/562,266, filed on Nov. 21, 2006.
(60) Provisional application No. 60/804,761, filed on Jun. 14, 2006.

(51) Int. Cl. H04N 5/225

(52) U.S. Cl. 348/169; 348/E05.024

(57) ABSTRACT

A tracking system having a video detector for associating observations of blobs and objects and deriving objects' or blobs' paths. Hypotheses may be computed by the system for merging, splitting and reacquisition of the observations. There may be objects tracked among the observations, and best paths selected as trajectories of corresponding objects. The observations may be placed in a sliding window containing a series of observations inferred from a collection of frames for improving the accuracy of the tracking (or data association). The processed observations and data may be represented graphically.

The present application claims the benefit of U.S. Provisional Application No. 60/804,761, filed Jun. 14, 2006. U.S. Provisional Application No. 60/804,761, filed Jun. 14, 2006, is hereby incorporated by reference.

The present application is a continuation-in-part application of U.S. patent application Ser. No. 11/548,185, filed Oct. 10, 2006. U.S. patent application Ser. No. 11/548,185, filed Oct. 10, 2006, is hereby incorporated by reference.

The present application is a continuation-in-part application of U.S. patent application Ser. No. 11/562,266, filed Nov. 21, 2006. U.S. patent application Ser. No. 11/562,266, filed Nov. 21, 2006, is hereby incorporated by reference.

### BACKGROUND

The present invention pertains to tracking and data association particularly to tracking and associating targets including those that may be temporarily occluded, merged, stationary, and the like. More particularly, the invention pertains to implementing techniques in tracking and data association.

### SUMMARY

The invention is a tracking system which that incorporates several hypotheses.

### BRIEF DESCRIPTION OF THE DRAWING

FIG. 1 is a diagram of detected observations versus time;

FIGS. 2a and 2b show additional graph information for merge and split hypotheses, respectively;

FIGS. 3a, 3b and 3c are pictures showing tracking results for merge, slit and reacquisition operations, respectively;

FIGS. 4a and 4b show a tracking of targets using ground plane information;

FIG. 5 is a diagram of an example tracking system;

FIG. 6 is a diagram of a multiple hypotheses module of the tracking system;

FIG. 7 is a diagram of a moving window used in the tracking system; and

FIG. 8 is a diagram of example paths of tracked objects.

### DESCRIPTION

Multiple target tracking and association is a key component in visual surveillance. Tracking may provide a spatio-temporal description of detected moving regions in the scene. Such low-level information may be critical for recognition of human actions in video surveillance. In the present visual tracking approach, the observations are the detected moving blobs, or detected stationary or moving objects (e.g., faces, people, vehicles . . . ). These observations may be referred to herein as blobs. An issue related to visual tracking may come from incomplete observations, occlusions and noisy foreground segmentation. The assumption that one detected blob corresponds to one moving object is not always true. Several factors may be needed to be considered for a good tracking algorithm as follows. A single moving object (e.g., one person) may be detected as multiple moving blobs, and thus the tracking algorithm should “merge” the detected blobs. Similarly, one detected blob may be composed of multiple moving objects; in this case, the tracking algorithm should “split” and segment the detected blob. A detected blob could be a false alarm due to erroneous motion or object detection. Here, the tracking algorithm should filter these observations. In the presence of static or dynamic occlusions of the moving objects in the scene, one may often observe a partial occlusion where the appearance information gets affected, or have a total occlusion where no observation on the object is available. The lack of observation may also correspond to a stop-and-go motion since the observation may come from motion detection. Also, the number of objects in the scene may vary as new objects enter and leave the field-of-view of a camera, or detection mechanism or module.

A graph representing observations over time may be adopted. A multiple-target tracking approach may be formulated as finding the best multiple paths in the graph. To use the visual observations from an image sequence, both motion and appearance models may be introduced. Given these models, one may associate a weight to each edge defined between two nodes of the graph. Due to noisy foreground segmentation, one target may report foreground regions, and one foreground region may correspond to multiple targets. To deal with the various issues, several types of operations, including merge, split and reacquisition (by appearance), may be introduced. If a prediction of one track at time t+1 has enough spatial overlapping with more than one observation at time t+1, a merge operation may generate a new observation. When an observation at time t+1 is the best child of more than one track, this may incur a split operation, which splits a node into several new observations. A reacquisition operation may be used to handle misdetection. New hypotheses may carry a hypothesis proposed by merge, split or reacquisition operation. A final decision about tracking may be made by considering all of the observations in the graph.

The present multiple-target tracking algorithm may be widely used in a visual surveillance application. An input for the tracking algorithm may include the foreground regions and original image sequences, or detected objects in the image. A foreground region usually can be provided by a motion detection procedure. An observation graph may be constructed, which contains all of the observations within a time period. An edge between nodes may be weighted by a joint motion and appearance likelihood. The motion likelihood may be computed with a Kalman Filter. The appearance likelihood may be the KL distance between two non-parametric appearance models. Next, one may perform an optimal path selection in the graph to find the best temporal and spatial trajectories of the targets.

Multiple-target tracking may be considered as a maximum a posterior (MAP) problem. To make full use of the visual observations from the image sequence, both motion and appearance likelihood may be introduced. The graph representation of all observations over time may be adopted. A final decision of the trajectories of the targets may be delayed until enough observation is obtained.

The observations may be expanded with hypotheses added by merge, split and reacquisition operations, which are designed to deal with noisy foreground segmentation due to occlusion, foreground fragment and missing detection. These added hypotheses may be validated during a MAP estimate. A MAP formulation of multiple target tracking approach and the motion and appearance likelihoods may be noted.

In a multiple-target tracking approach, an objective is to track multiple target trajectories over time given noisy measurements provided by a motion detection algorithm. The targets' positions and velocities may be automatically initialized and should not require operator interaction, or could be provided by the operator. The detector may usually provide image blobs which contain the estimated location, size and the appearance information as well. Within any arbitrary time span [1, T], there may be K unknown number of targets in the monitored scene. yₜ={yₜⁱ:i=1, . . . , nₜ} may denote the observations at time tₜ and Y=∪_{tε{1, . . . , T}}yₜ may be the set of all the observations within the duration [1, T]. The multiple target tracking can be formulated as finding the set of K best paths {τ₁, τ₂ . . . , τ_{K}} in the temporal and spatial space, where K is unknown. Let τₖ denote a track by the set of its observations: τₖ={τₖ(1), τₖ(2), . . . , τₖ(T)} where τₖ(t)εyₜ represents the observation of track τₖ at time t.

A graph representation G=<V,E> of all measurements within time [1, T] may be utilized. The graph is a directed graph that consists of a set of nodes V={yₜ^{k}:t=1, . . . T, k=1, . . . , K}. Considering missing detections, one special measurement of yₜ⁰ may represent the null measurement at time t. A directed edge, (yₜ_{₁}ⁱ, yₜ_{₂}^{j})εE,t₁<t₂, may be defined between two nodes in consecutive frames based on proximity and similarity of the corresponding detected blobs. In each time instant, there may be mₜ observations. The shaded node 12, which does not belong to any track, may represent a false alarm. The white node 13 may represent a missing observation, as inferred by the tracking.

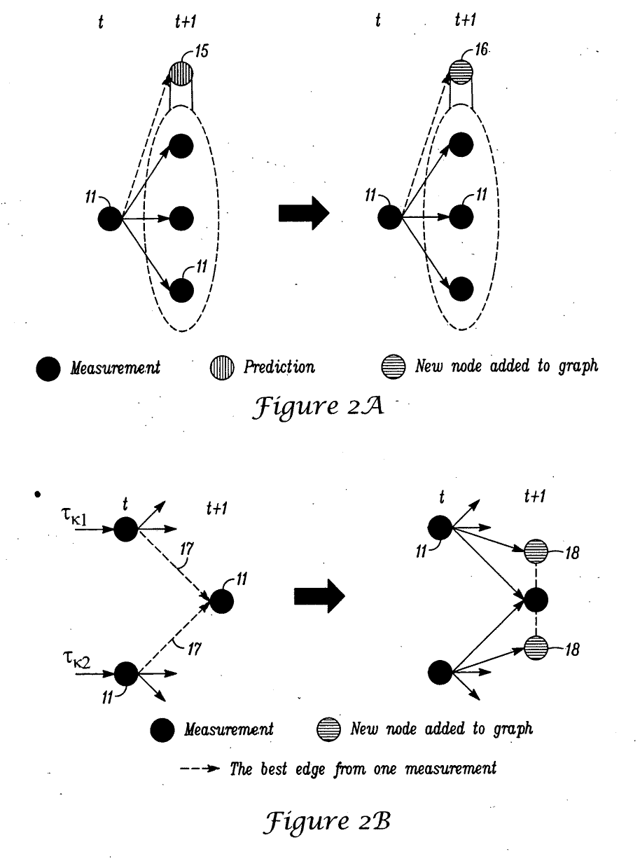

FIG. 2a shows a hypothesis added by a merge operation. Node 15 is prediction on the left at t+1. Node 16 is a new node added to the graph on the right at t+1. FIG. 2b shows a hypothesis added by a split operation. Best edges 17 are on the left from a measurement. New nodes 18 are added to the graph on the right.

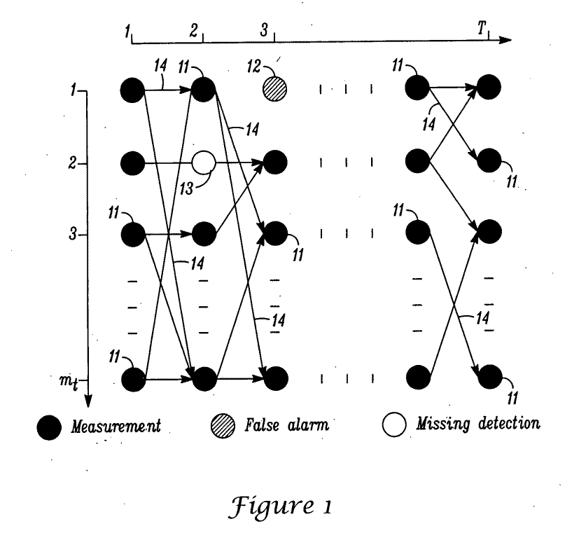

The multiple target tracking may be formulated as a maximum a posterior (MAP) problem, given the observations over time, to find K best paths τ*_{1, . . . , K} through the graph of measurements in FIG. 1 as

τ*_{1, . . . , K}=arg max(P(τ*_{1, . . . , K}|Y)). (1)

The posterior of the K best paths may be represented as the observation likelihood of the K paths and the prior of the K paths. A prior distribution model of P(τₖ:k=1, . . . , K) may be represented as

$$P ( {τ}_{1 , … , K} ) = {\prod }_{i = 1}^{T} {{p}_{d}^{{T}_{m}^{i}} ( 1 - {p}_{d} )}^{K - {T}_{m}^{i}} p ( {F}_{m}^{i} ) , \qquad ( 1 )$$

where Tₘⁱ is the number of measurements associated to the tracks and Fₘⁱ is the number of measurements not associated to the tracks. p(Fₘⁱ) may be a Poisson distribution of Fₘⁱ, and p_{d} denotes the detection rate which may be estimated from the prior knowledge of the detection procedure. By introducing this prior information, the posterior of the unknown K paths may be represented as

P(τ_{1, . . . , K}|Y)∝P(Y|τ_{1 . . . K})P(τ_{1, . . . , K}). (2)

The K paths multiple target tracking may be extended to a MAP estimate as

τ*_{1, . . . K}=arg max(P(Y|τ_{1 . . . , K})P(τ_{1, . . . , K})). (3)

Since the measurements are image blobs, besides position and dimension (width and height) information, an appearance model may be considered in the tracking approach. To make full use of the visual cues of the observations, both motion and appearance may be considered as likelihood measures. By assuming each target is moving independently, the joint likelihood of the K paths over time [1, T] may be represented as

$$P ( Y \vert {τ}_{1 , … , K} ) = {\prod }_{k = 1}^{K} {P}_{motion} ( {τ}_{k} ( 1 ) , … , {τ}_{k} ( T ) ) {P}_{color} ( {τ}_{k} ( 1 ) , … , {τ}_{k} ( T ) ) . \qquad ( 4 )$$

A joint probability may be defined by a product of the appearance and motion probabilities. This probability maximization approach may be inferred by using a Viterbi™ algorithm (see Kang et al., “Continuous tracking within and across camera streams”, IEEE, Conference on CVPR 2003, Madison, Wis., which is hereby incorporated by reference). Other algorithms may be utilized.

A constant velocity motion model in a 2D image plane and 3D ground plane may be considered. xₜ^{k}, may denote the state vector of the target k at time t to be [lₓ, l_{y}, w, h, iₓ, i_{y}, l_{gx}, l_{gy}] (position, width, height and velocity in 2D image, position on the ground plane). One may consider a linear kinematic model,

xₜ₊₁^{k}=A^{k}xₜ^{k}+wₜ^{k}, (5)

where xₜ^{k} is the state vector for target k at time t. wₜ^{k} may be assumed to have a normal probability distribution, w^{k}˜N(0, Q^{k}). A^{k} may be a transition matrix. A constant velocity motion model may be used. The observation yₜ^{k}=[uₓ,u_{y},w,h,u_{gx},u_{gy}] may contain a measurement of a target position and size in a 2D image plane and position on a 3D ground plane. Since observations often contain false alarms, the observation model may be represented as

$${y}_{t}^{k} = \{ \begin{matrix}{H}^{k} {x}_{t}^{k} + {v}_{t}^{k} & if from target \\ {δ}_{t} & false alarm ,\end{matrix} \qquad ( 6 )$$

where yₜ^{k} represents the measurement which may arise either from a false alarm or from the target. δₜ may be the false alarm rate at time t. The H^{k} matrix may serve also to take into account the ground plane as one could use it to map 2D observations to 3D measurements. A measurement may be provided as a linear model of a current state if it is from a target otherwise is modeled as a false alarm δₜ, which is assumed to be a uniform distribution.

\hat{τ}ₖ(tᵢ) and \hat{P}ₜ(τₖ) may denote a posterior state estimate and a posterior estimate of the error covariance matrix τₖ at time t. Along a track τₖ, the motion likelihood of one edge τₖ(t₁), τₖ(t₂))εE, t₁<t₂, may be represented as Pₘₒₜᵢₒₙ(τₖ(t₂)|\hat{τ}ₖ(t₁)). Given the transition and observation model in a Kalman filter, the motion likelihood may then be written as

$${P}_{motion} = ( {τ}_{k} ( {t}_{2} ) \vert {\hat{τ}}_{k} ( {t}_{1} ) = \frac{1}{{( 2 π )}^{3 / 2} det ( {\hat{P}}_{{t}_{2}} ( {τ}_{k} )} exp ( \frac{- {e}^{T} {\tilde{P}}_{{t}_{2}}^{- 1} ( {τ}_{k} ) e}{2} ) , \qquad ( 8 )$$

where e=yₜ^{k}−HA\hat{τ}ₖ(t₁) and \tilde{P}ₜ_{₂}(τₖ) may be computed recursively by a Kalman filter as \tilde{P}ₜ_{₂}(τₖ)=H(A\hat{P}ₜ_{₂}₋₁(τₖ)A^{T}+Q)H^{T}+R. \hat{P}ₜ_{₂}₋₁(τₖ) is the state posterior estimate which can be computed from the Kalman filter.

The tracking of each region may rely on the kinematic model, described herein, as well as on an appearance model. The appearance of each detected region may be modeled using a non-parametric histogram. All RGB bins may be concatenated to form a one dimension histogram. The appearance likelihood between two image blobs, τₖ(t₁), τₖ(t₂))εE, t₁<t₂, in track k, may be measured using a symmetric Kullback-Leibler (KL) divergence defined in the following.

$${P}_{color} ( {τ}_{k} ( {t}_{2} ) \vert {\hat{τ}}_{k} ( {t}_{1} ) ) = \frac{1}{2} {\sum }_{c = r , g , b}^{ } ( {P}_{i} ( c ) - {P}_{j} ( c ) ) log ( \frac{{P}_{i} ( c )}{{P}_{j} ( c )} ) \qquad ( 9 )$$

other appearance models may be used by the present framework also.

Given the motion and appearance models, one may associate a weight to each edge defined between two nodes of the graph. This weight may combine the appearance and motion likelihood models presented herein.

In equations (7) and (9), one may assume the state of the target at time t as determined by the previous state at time t−1 and the observation at time t as a function of the state at time t alone, i.e., a Markov condition. Also one may assume the motion and appearance of different targets is independent. Thus, the joint likelihood of K paths in equation (5) may be factorized as in the following.

$$P ( Y \vert {τ}_{1 , … K} ) = {\prod }_{k = 1}^{K} {\prod }_{( {t}_{1} , {t}_{2} ) ∈ {τ}_{k}}^{T} {P}_{motion} ( {τ}_{k} ( {t}_{1} ) \vert {\hat{τ}}_{k} ( {t}_{2} ) ) {P}_{color} ( {τ}_{k} ( {t}_{1} ) \vert {\hat{τ}}_{k} ( {t}_{2} ) ) \qquad ( 10 )$$

An augmented graph representation for a multiple hypothesis tracker may be provided. Many multiple target tracking algorithms assume that no two paths pass through the same observation. This assumption appears reasonable when considering punctual observations. However, this assumption may often be violated in the context of a visual tracking situation, where the targets are not regarded as points and the inputs to the tracking algorithm are usually image blobs. A framework may be presented to handle split and merge behavior in estimating the best paths.

Merge and split hypotheses may be considered. Merge and split behaviors may correspond to a recursive association of new observations, given estimated trajectories. At a given time instant t, one may obtain K best paths which are denoted as [τ₁^{t}, . . . , τ_{K}^{t}]. Using the estimated tracks, one may evaluate how the mₜ₊₁ observations {yₜ₊₁ⁱ:i=1, . . . , mₜ₊₁} at time t+1 fit the estimated tracks which end at time t. The spatial overlap between an estimate state at instant time t and a new observation may be considered as a primary cue. Several cases may be noted. First, if a prediction of τ̅ₖ^{t}(t+1) has sufficient spatial overlap with more than one observation at time t+1, this may trigger a “merge” operation which merges the observations at time t+1 into one new observation. This new observation carrying the merge hypothesis may be added to the graph of FIG. 1 but for illustrative purposes is shown separately in FIG. 2a.

Second, if the predicted positions and shapes of more than one track spatially overlap within one observation y*ₜ₊₁ at time t+1, then the set of candidate tracks may be κ,|κ|>1. The “split” operation may proceed as in the following. For each track τₖ^{t} in κ whose prediction has sufficient overlap with y*ₜ₊₁, one may change the predicted size and location at time t+1 to find the best appearance score sₖ=P_{color}( τ̅ₖ^{t}(t+1), y*ₜ₊₁); provide a new observation mode for the track with the largest sₖ which may be added to the graph of FIG. 1; and reduce the confidence of the area occupied by the newly added node and recompute the score sₖ for each track left in κ. One may iterate this approach until all of the candidate tracks in κ that overlapped with the observation y*ₜ₊₁ are tested. Even though the new observation carrying the merge hypothesis may be added to the graph of FIG. 1, for illustrative purposes, it is shown separately in FIG. 2b.

A reacquisition hypothesis may be considered. Noisy segmentation of foreground regions often provides incomplete observations not suitable for a good estimation of the position of the tracked objects. Indeed, moving objects are often fragmented, several objects may be merged into a single blob, and thus regions are not necessarily detected in a case of stop-and-go motion.

Additional information may be incorporated from the images for improving appearance-based tracking. Since the appearance histogram of each target has been maintained at each time t, the reacquisition operation may be introduced to keep track of the appearance distribution when the blob does not provide good enough input. The reacquisition approach may be regarded as a mode-seeking approach and be successfully applied to a tag-to-track situation. Often the central module of the tracker may be doing reacquisition iterations to find the most probable target position in the current frame according to the previous target appearance histogram. In the present multiple target tracking situation, if a reliable track is not associated with a good observation at time t, due to a fragmented detection, non-detection or a large mismatch in size, one may instantiate a reacquisition algorithm to propose the most probable target position given the appearance of the track. One may note that the histogram used by the reacquisition algorithm may be established using past observations along the path (within a sliding window), instead of using only the latest one. Using a predicted position from the reacquisition, a new observation may be added to the graph. The final decision may be made by considering all of the observations in the graph. To prevent reacquisition tracking from tracking a target after it leaves the field of view, the reacquisition hypothesis may be considered only for trajectories where the ratio of the real node to the total number of observations along the track is larger than a certain threshold.

In use of the present system, a sliding temporal window of 45 frames may be used to implement the present algorithm as an online algorithm. The graph may contain observations between time t and t+45. When new observations are added to the graph, the observations older than t may be removed from the graph.

The present tracking algorithm may be tested and used on both indoor and outdoor data sets. The data considered may be collected inside of a laboratory, and around parking lots and other facilities. In the considered data set, a large number of partial or complete occlusions between targets (pedestrians and vehicles) may be observed. In conducted tests, the input considered for the tracking algorithm may include the foreground regions and the original image sequence. One may test the accuracy of the present tracking algorithm and compare it to the classical approaches without the added merge, split and reacquisition hypotheses.

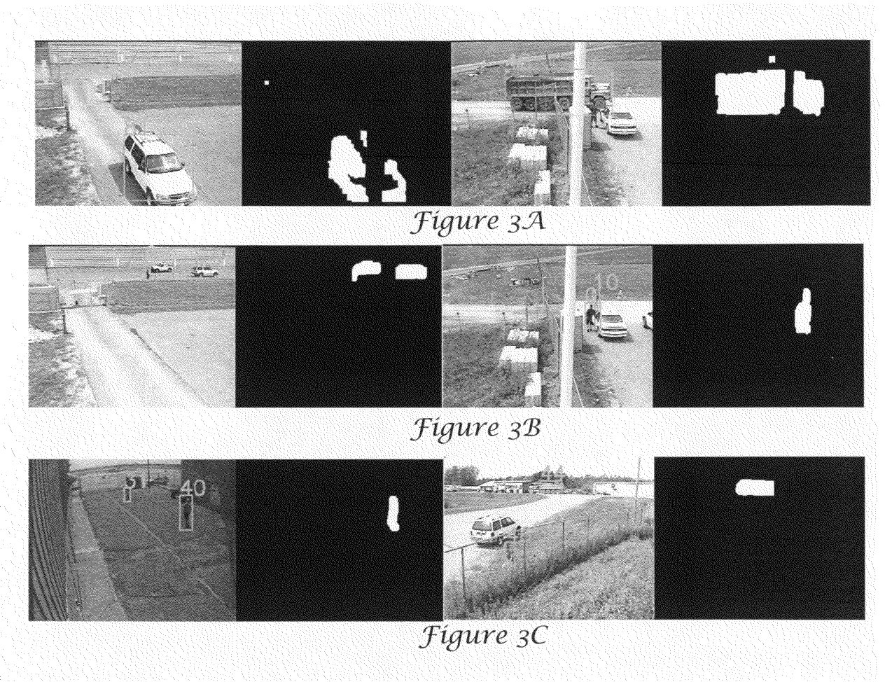

FIGS. 3a-3c show data sets with tracking results overlaid and the foreground detected. Due to noisy foreground segmentation, the input foreground for one target could have multiple fragment regions, as shown in FIG. 3a. This Figure shows a tracking result with a merge operation when the foreground regions fragment.

The case where two or more moving objects are very close to each other, one may have a single moving blob for all of the moving objects, as shown in FIG. 3b. This Figure shows a tracking result with a split operation when the foreground regions merge.

In the case where the targets merge into the background is shown in FIG. 3c. This Figure shows a tracking result with a reacquisition operation when a missing detection happens.

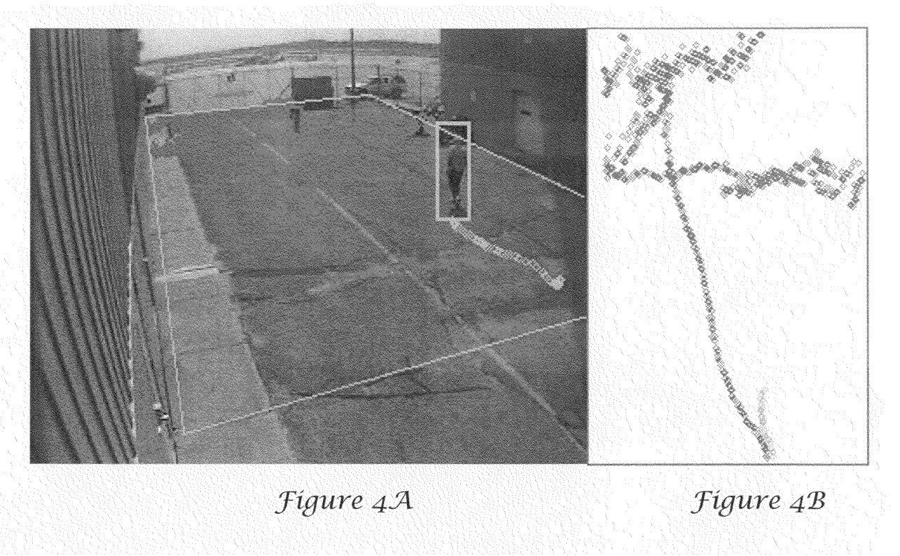

Given the homography between the ground plane and the image plane, the targets may be tracked on the 3D ground plane, as shown in FIGS. 4a and 4b. These Figures show tracking targets using ground plane information. In FIG. 4a, estimated trajectories are plotted in the 2D image. In FIG. 4b, the positions of moving people in the scene are plotted on the ground plane.

The present approach may be used for multiple targets tracking in video surveillance. If the application scenarios are partitioned into easy, medium and difficult cases, many tracking algorithms may handle the easy cases rather well. However, for the medium and difficult cases, multiple targets could be merged into one blob especially during the partial occlusion and one target could be split into several blobs due to noisy background subtraction. Also, missed detections may happen often in the presence of stop-and-go motion, or when one is unable to distinguish foreground from background regions without adjusting the detection parameters to each sequence considered.

The mechanism introduced here is based on multiple hypotheses which expand the solution space. The present formulation of multiple-target tracking as a maximum posterior (MAP) and the extended set of hypotheses by considering merge, split and reacquisition operations is very robust. It may deal with noisy foreground segmentation due to occlusion, foreground fragments and missing detections. It shows good performance on various data sets.

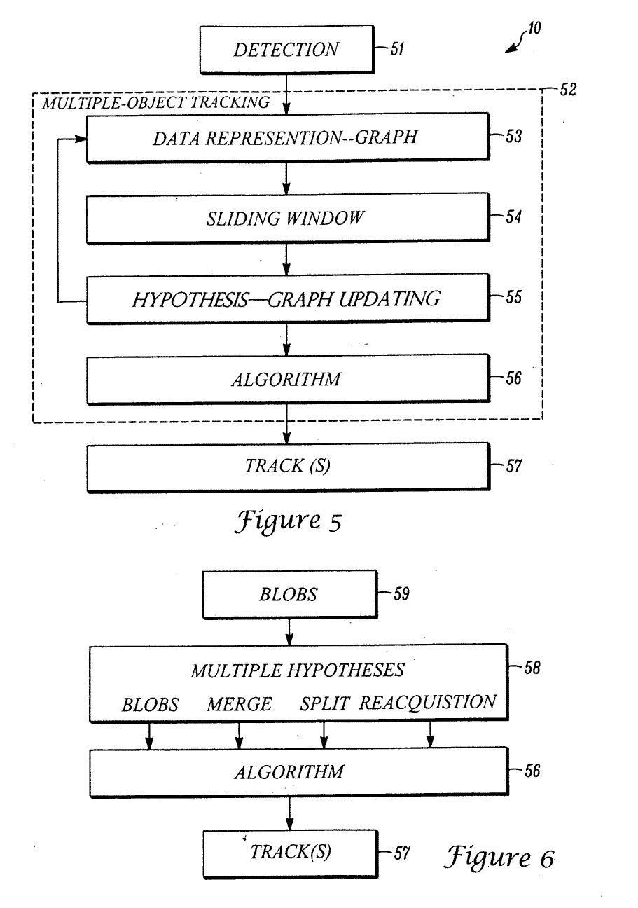

FIG. 5 is a diagram of a multiple tracking system 10. A detection module 51 may provide video images of a scene with blobs detected or objects to be tracked. The detection may be based on images of blobs or objects or on motion of these blobs or objects. An output of the detection module 51 may go to a multiple-object tracking mechanism 52. The image data from the detection module 51 may proceed on to a data representation mechanism or module 53 that represents the data in the form of a graph as illustrated in FIGS. 1, 2a and 2b. The data representation may proceed on to a sliding window module 54, which may provide a delay or other shift in time to a frame of data being processed. The results of the tracking module 54 may go to a graph updating module 55 which provides updates of tracking to the graph maintained by module 53. This updating may be incremented in terms of frame of blob or object tracking. Results of the tracking module 53 may go to an algorithm module 56 for processing the results according to the various hypotheses of merge, split and reacquisition. The algorithm may be that of the Viterbi™ algorithm noted herein, or another appropriate algorithm. The tracks module 57 may receive an output from the algorithm module which results in tracks determined from the video information of the detection module 51.

FIG. 6 is a diagram revealing further detail of the operation of a portion of system 10. Module 59 may provide observations or blobs to a multiple hypothesis module 58. Blob, merge, split and reacquisition operation data may be provided to algorithm 56 from module 58.

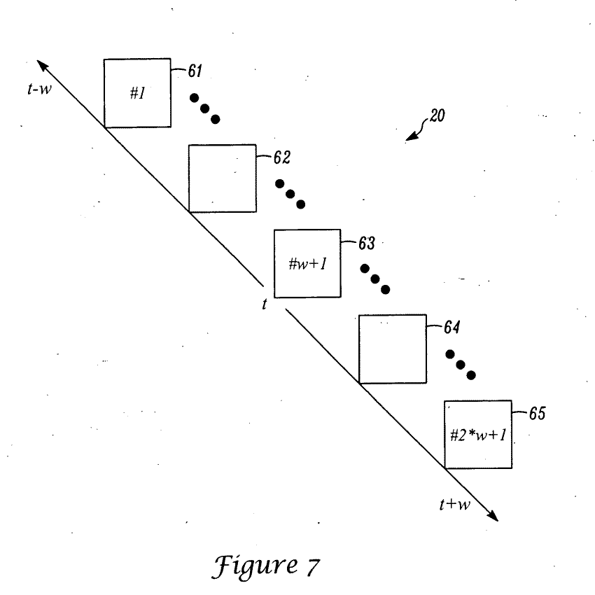

FIG. 7 shows a sliding window approach 20. The approach may provide a series of frames. The frames may contain occurrences of contained information according to time. Frame 63 at time t may be the one being processed at that time. The frames prior to the frame 63 may include frame 61 which goes back to the beginning of the series of sliding window 20, and include frame 65 which goes forward in time, along with frames 62 and 64 between the frames 61 and 65. There may be 22 frames prior to frame 63 in time, and 22 frames after frame 63 in time. Frames 62 and 64 are merely representative of the frames between frames 61 and 63 and frames 61 and 65, respectively. Frame 61, the first frame of the sliding window 30 may be at time t−w. The “−w” may represent the time of the 22 frames prior to the “present” frame 63 at time t. Frame 65, the last frame of the sliding window 20, may be at t+w. The“+w” may represent the time of the 22 frames after the “present” frame 63 at time t. The total number of frames of the sliding window approach 20 is 2*w+1.

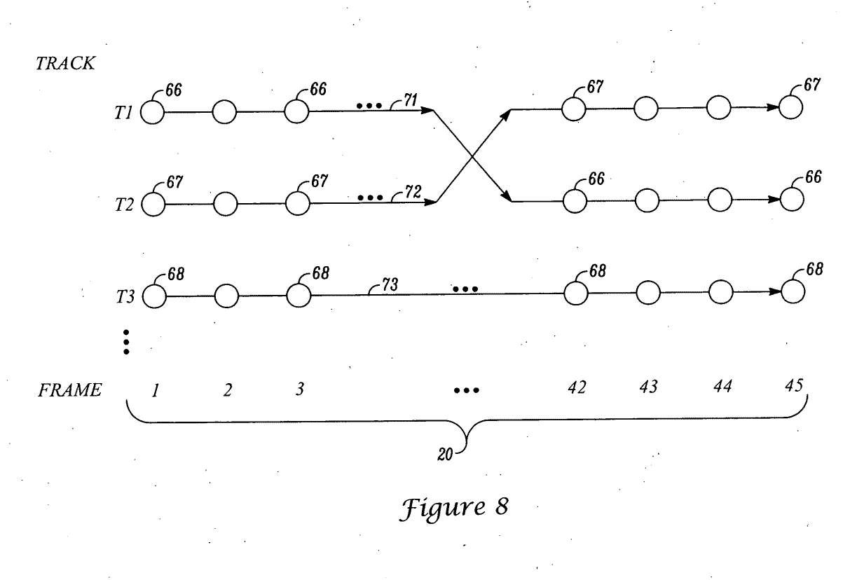

FIG. 8 is a diagram of tracks T₁, T₂, T₃, and so on, of objects. The tracks 71, 72, and 73 of objects 66, 67 and 68, respectively, relative to the paths may be noted. The sliding window 20 may have 45 frames; although for clarity, just frames 1-3 and 42-45 are shown. The direction and the numbering order of the frames could in some circumstances be arbitrarily selected. It may be noted that objects 66 and 67 appear to start out on tracks that follow an apparently straight-line like path. However, the present tracking mechanism may note a cross-over of paths by objects 66 and 67, which may be detected through the operation of one or more hypotheses of merge, split and reacquisition, on the data in one or more of the 45 frames of window 20. On a display screen connected to a processor of the system 10, one may mouse click on an object or blob of interest to individually track its movement.

In the present specification, some of the matter may be of a hypothetical or prophetic nature although stated in another manner or tense.

Although the invention has been described with respect to at least one illustrative example, many variations and modifications will become apparent to those skilled in the art upon reading the present specification. It is therefore the intention that the appended claims be interpreted as broadly as possible in view of the prior art to include all such variations and modifications.

What is claimed is:

1. A tracking system comprising:
a detection module;
a tracking mechanism connected to the detection module; and
a track output module connected to the tracking mechanism; and
wherein the tracking mechanism is for applying a merge, split and/or reacquisition operation on an output of the detection module.

2. The system of claim 1, wherein the tracking mechanism comprises:
a data representation module;
a window module connected to the data representation module;
a data representation update module connected to the window module and the data representation module; and
a tracking algorithm connected to the data representation update module.

3. The system of claim 2, wherein the data representation update module is for adding hypotheses from the merge, split and/or reacquisition operation.

4. The system of claim 3, wherein the data representation update module is for providing data from the merge, split and/or reacquisition operation to the data representation module.

5. The system of claim 2, wherein the data representation module is for putting the observations and inferences in a form of a graph.

6. The system of claim 2, wherein the window module comprising a sliding window for providing a delay to the data for determining a best path of a plurality of paths of one or more blobs, to be a track of an object.

7. The system of claim 3, wherein the hypotheses are effected along with motion and/or appearance likelihood models of blobs or objects.

8. A tracking system comprising:
a detection module;
a data representation module connected to the detection module;
a sliding window module connected to the data representation module;
a hypothesis module connected to the sliding window module and to the data representation module; and
an algorithm module connected to the hypothesis module.

9. The system of claim 8, further comprising a track output module connected to the algorithm module.

10. The system of claim 8, wherein the detection module is for obtaining observation data.

11. The system of claim 10, wherein the data representation module is for providing observation data in a graph format.

12. The system of claim 10, wherein the hypothesis module is for applying a merge, split and/or reacquisition operation to the observation data.

13. The system of claim 8, wherein the sliding window module is for providing a shift in time to a frame of observation data.

14. The system of claim 8, wherein matching a blob to a path is based, at least in part, on a motion likelihood and/or an appearance likelihood of the blob relative to an expected blob or another blob.

15. The system of claim 14, wherein a best path is selected from a plurality of observed paths to be a track of the blob.

16. The system of claim 15, wherein the blob having a track is of an object being tracked.

17. A method for tracking comprising:
obtaining data about one or more blobs being observed;
applying hypotheses of merge, split and/or reacquisition to the data;
updating the data with additional data resulting from an application of one or more of the hypotheses to the data; and
computing tracks and estimating objects' positions from the one or more paths of the one or more blobs from updated data, and matching the tracks and objects on a one-to-one basis.

18. The method of claim 17, further comprising moving the data being processed in time with a sliding window having a series of frames.

19. The method of claim 18, further comprising representing the data graphically.

20. The method of claim 19, wherein the computing is performed with a Viterbi™ algorithm.
